(19) United States
(12) Patent Application Publication
(10) Pub. No.: US 2012/0152289 A1
(43) Pub. Date: Jun. 21, 2012

(54) Sterilization Container With Disposable Liner

(76) Inventors: Tara Denise Smith, Marietta, GA (US); Joseph A. Cesa, Cumming, GA (US); Corinna Schwarz, Roswell, GA (US); Jeffrey J. Farmer, Roswell, GA (US); Sean P. Gorman, Cumming, GA (US); Marion L. Ladd, Alpharetta, GA (US); Emily A. Reichart, Atlanta, GA (US); Dwayne J-K Jackson, Atlanta, GA (US)

(21) Appl. No.: 12/974,391

(22) Filed: Dec. 21, 2010

(51) Int. Cl. B08B 3/00

(52) U.S. Cl. 134/109

(57) ABSTRACT

A container for sterilizing and storing surgical materials and preserving surgical materials in a sterilized condition is disclosed herein. The container includes a lid, liner and in many embodiments, a frame. The lid and liner are desirably disposable and recyclable after a single use while the frame should be reusable many times. The liner and optionally the lid is substantially transparent so that a user can inspect the instruments while the container is closed without compromising the sterile nature of the inside of the container.

Medical equipment is sterilized prior to surgical use in order to avoid harmful and infectious microbes being introduced to patients. There are two generally available methods of performing sterilization of medical equipment. One of the methods involves the use of a “sterilization wrap” fabric and the other uses a sterilization container into which the instruments are placed.

Sterilization wrap is used by enveloping the medical equipment with the wrap, which is generally made of a gas permeable material like a non-woven fabric. Examples of such wraps may be found in U.S. Pat. No. 6,406,674, which describes a wrap of two layers bonded in such a way as to remain visibly two layers to a casual viewer. This wrap is superior to single layer wraps as it provides greater resistance to wear and tear.

Regarding sterilization wraps; sterilization wraps are made of a relatively thin, flexible material and have low initial cost and are typically disposable, i.e., discarded after a single use. Items to be sterilized are usually placed within a metal sterilization tray prior to wrapping the items with sterilization wrap. These sterilization trays have pointed edges or other features that may concentrate forces and generate very small tears or snags if the wrap contacts them. When wrapped trays are transported on carts or stacked prior to sterilization or after sterilization, other sources of very small tears or breaches in the barrier may develop in the wrap due to pressure or impact. These tears may allow contaminates to reach the items. The result is added expense because the items need to re-handled, re-wrapped and re-sterilized.

In addition, because sterilization wraps are not transparent, the medical professional cannot visually inspect the items within the wrap for content or for assurance that the sterilization procedure has been completed. This can lead to a medical professional opening the wrong sterilization tray during a procedure and/or lead to lack of confidence that the tray is truly sterilized. As a result, trays and articles may require unnecessary re-handling and re-sterilization, wasting time and money.

Rigid sterilization containers are generally rectangular boxes having a bottom and top or lid. Items to be sterilized, e.g. medical instruments, are placed in the container or more particularly into a standard metal hospital basket, which is then placed into the container. The container is then placed in a sterilization device for a time certain to kill any bacteria or other microorganisms inside it. Sterilization is performed by the introduction of a gas, typically steam or ethylene oxide for a pre-determined time. The container has a gas permeable filter located on one of its surfaces to allow the passage of the sterilizing gas but not the passage of microorganisms. This allows the inside of the container to be successfully sterilized and to maintain its sterility after the procedure has been completed.

The rigid sterilization containers are also generally reusable and so the hospital must have a process and facilities for cleaning the containers, storing them between uses, and returning them to the proper place for reuse. These containers must also be checked for wear and damage on a reasonable basis to ensure proper sterilization and that the sterilized items remain sterile until they are needed for a surgical procedure. After the containers have been used for some time, warping or dents on the rims can result in a very rapid re-contamination of the sterilized items. Ultimately, these containers must be repaired, reconditioned, or discarded.

Reusable vented rigid sterilization containers, although generally effective, must be well maintained and cleaned between uses so that they may be re-used. This maintenance and cleaning of course requires hospital resources. Additionally, the longer the containers are in use, the less confidence clinicians have in the sterilization efficacy of the containers. In addition, containers without a transparent section do not allow the user to inspect the contents of the container.

Thus, there remains a need in the art for sterilization containers that are economical to use, provide ease of visual inspection and use, and that impart confidence in the sterility of their contents among clinicians.

### SUMMARY

The present disclosure provides a locking container for sterilizing and preserving surgical materials in a sterilized condition. The container can fit a basket for containing surgical instruments and has a lid, a liner and a lock for holding the lid and liner together. A frame that is large enough to receive the liner and basket may also desirably be used. The frame has a rim that can mate with the lip on the lid to create a barrier to infiltration of microorganisms after the container has been sterilized.

The frame may have a plurality of feet adapted to enable multiple frames and lids to be stacked one on top of the other. The feet may be designed to overhang the majority of the lid of the lower container or, alternatively, may be designed to rest in a like number of depressions in the lid of the lower container. If the feet overhang the majority of the lid of the lower container, they rest upon the lip of the lid. This transfers the weight of the upper container(s) onto the lip and to the frame.

The liner is meant to be disposable and recyclable, i.e. for single use, and is desirably made from polypropylene, polyethylene, polyesters, thermoplastic polyurethanes, olefinic copolymers, aluminum, copper or various alloys. The liner is desirably very thin as it must merely hold the instrument basket while being supported by the frame. The lid may likewise be disposable and recyclable after a single use. The optional frame is intended to be reusable many times prior to recycling. The basket may be the standard reusable hospital-type instrument basket or may be a disposable basket made from a thin metal like aluminum.

The liner is desirably substantially transparent so that a user may view the instruments to be sure that the correct container for the surgery at hand is being prepared. All or part of the liner should be transparent, desirably at least the sides. The lid may also be transparent for the same reason as the liner.

In another embodiment, an extension that is placed on top of the basket to raise the height of the basket may be used. This provides greater volume in which to place medical instruments to be sterilized. In this embodiment the basket with extension is placed in a polymeric bag for sterilization. The polymeric bag is sealed closed prior to sterilization and disposed of, preferably by recycling, after sterilization.

In still another embodiment, for those embodiments using a lid and frame, the rim of the liner may include a material that is heat activated during steam sterilization to secure the lid and/or the frame to the liner. Such materials include hot melt adhesives made from polyolefins, block copolymers, resins, waxes and combinations thereof, that have a melting point below 270° F. (132° C.). Alternatively, in another embodiment, single sided tape may be adhered to the top and bottom sides of the liner, the tape acting as a gasket between the lid and liner on the top and between the liner and frame on the bottom.

The lid of the container desirably has a gas permeable filter is desirably in the central portion of the lid. The liner may also have a gas permeable filter in addition to or to the exclusion of the lid and may have more than one gas permeable filter, e.g. one on either side. The filter allows the gas used for sterilization to enter the container and sterilize the instruments inside and also prohibits microorganisms from entering the container after sterilization. The filter material does, however, permit the entry of air after sterilization. The filter material may be medical grade paper, polyolefin meltblown materials and nonwoven laminate materials such as laminates of spunbond materials and meltblown materials. The gas permeable filter material should be permeable to water vapor in order to allow any moisture from the steam sterilization process to escape. The filter should have a minimum water vapor transmission rate (WVTR) of about 200 g/m²/16 hours, calculated in accordance with ASTM Standard E96-80.

### BRIEF DESCRIPTION OF DRAWINGS

FIG. 1 is an illustration showing an exploded view of an exemplary locking sterilization container. The lid, instrument basket, liner and frame are shown separated from their normal nesting configuration for ease of viewing each component.

FIG. 2 is an illustration showing a cross-sectional view of an exemplary locking sterilization container showing a tortuous path created by the sandwiching of the liner between the lip of the lid and the rim of the frame.

FIG. 3 is an illustration showing a perspective view of a single exemplary locking sterilization container in which the lid and the frame are secured together and the frame has stacking feet that extend beyond the lid.

FIG. 4 is an illustration showing a perspective view of an exemplary locking sterilization container in which two containers are shown stacked one on top of the other using feet that rest in depressions on the lid of the lower container.

FIG. 5 is an illustration showing a perspective view of an exemplary locking sterilization container in which two containers are shown stacked one on top of the other using feet that extend beyond the lid to rest on the rim of the lower container.

FIG. 6 is an illustration showing a perspective view of a sterilization container using a film outer liner, a thin inner metal container to replace the hospital's existing instrument basket, and the lid.

FIG. 7 is a cut-away view of an extension placed on top of the hospital's instrument basket to raise its height, and a large disposable polymeric bag enveloping the basket and extension, for sterilization.

### DETAILED DESCRIPTION

The present disclosure provides a locking container for sterilizing and storing surgical materials and aseptically opening and aseptically preserving surgical materials in a sterilized condition. These containers offer an increased level of confidence of the sterility of the contents. Many of the components of the container are disposable, so there is no concern about contamination from previous uses, nor about warping or damage to the container causing a problem with maintenance of the seal.

The disclosure will be described with reference to the following description and figures which illustrate certain embodiments. It will be apparent to those skilled in the art that these embodiments do not represent the full scope of the disclosure which is broadly applicable in the form of variations and equivalents as may be embraced by the claims appended hereto. Furthermore, features described or illustrated as part of one embodiment may be used with another embodiment to yield still a further embodiment. It is intended that the scope of the claims extend to all such variations and embodiments.

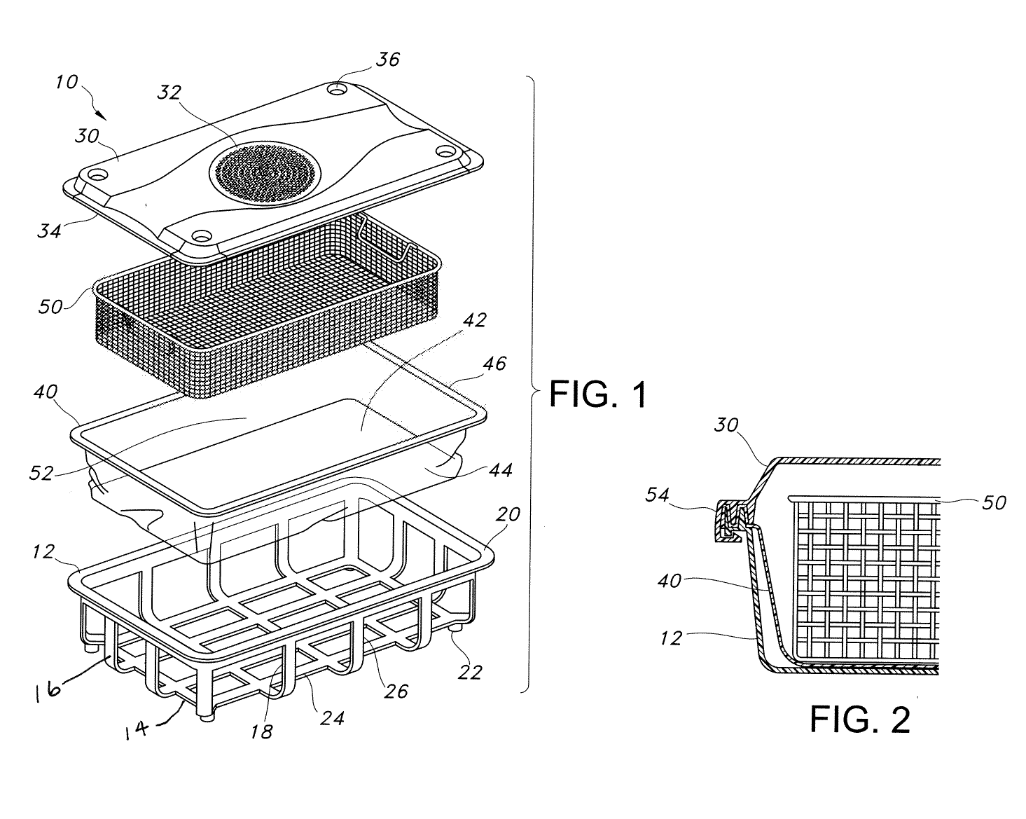

Referring now to FIG. 1, there is illustrated an exemplary locking sterilization container 10 having a disposable liner 40 that may be used for only a single sterilization cycle or single use. The locking sterilization container 10 includes a reusable frame 12, a lid 30 with a permeable filter 32, and a liner 40 that is adapted to accept a standard hospital instrument basket 50. The liner is adapted to sit in the frame and has a rim 46 that rests between the frame and lid. The liner is designed to be large enough to allow the basket to be placed inside of it and for the lid to properly close onto the frame and liner rim without touching the basket.

The frame 12 includes a base 14, a plurality of sides 16 each having a proximal portion in communication with the base 14 and a distal portion 18 away from the base, and a rim 20 defined by the distal portions 18 of the sides. The rim 20 forms or includes a lower portion of a barrier 54 as discussed above, between liner rim and frame.

The lid 30 includes a central portion and a lip 34, the lip forms or includes an upper portion of a barrier 54 between the liner rim and lid. When the lid 12 and the tray 14 are secured together, they enclose a chamber 52 for containing surgical materials. The chamber is sized to accept the basket and liner. The joining together of the lid and tray with the liner sandwiched between creates a barrier or gasket that functions to keep microorganisms from entering the chamber after sterilization. It is important, therefore, that the lid, liner and frame are adequately secured together. A number of systems of locking or securing mechanisms are available to secure the lid and frame together. Such systems will be discussed in greater detail below.

The disposable liner 40 is constructed of an inexpensive material like polyolefin film or very thin metal (e.g. aluminum) and comprises a base 42, sides 44 and rim 46. The liner rim 46 functions as a gasket or barrier seal between the lip 34 and the frame rim 20, to desirably seal the sterilization container and keep contaminants out of the container. When the lip 34 and the rim 20 are properly secured together, they form a barrier 54 to inhibit the passage of microorganisms into the chamber 52 between the frame 12 and lid 30. The barrier 54 may desirably define a tortuous path from the outside of the container to the chamber 52 to inhibit the passage of microorganisms as illustrated in FIG. 2. Alternatively, the liner rim may function as a gasket seal between the frame rim and the lid to produce a barrier 54 to inhibit the passage of microorganisms. This seal may be provided by various liner rim materials or mechanisms such as, for example, a gasket, pliable material and/or heat sensitive material that is adapted to melt, deform or otherwise change shape to block to the passage of microorganisms between the frame and the lid in to the chamber.

The disposable liner 40 can be stored prior to use in a nested configuration. This allows a container of disposable liners, for example, to be stored in the sterilization preparation area and to take up very little storage space. The liners may be nested like disposable cups or bowls in a box and packaged in large numbers for easy access.

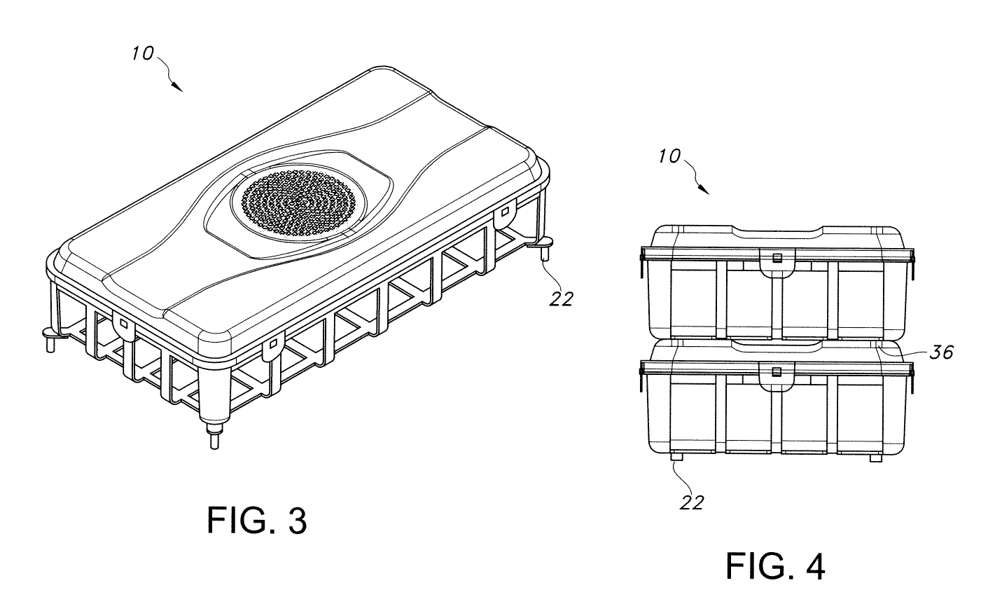

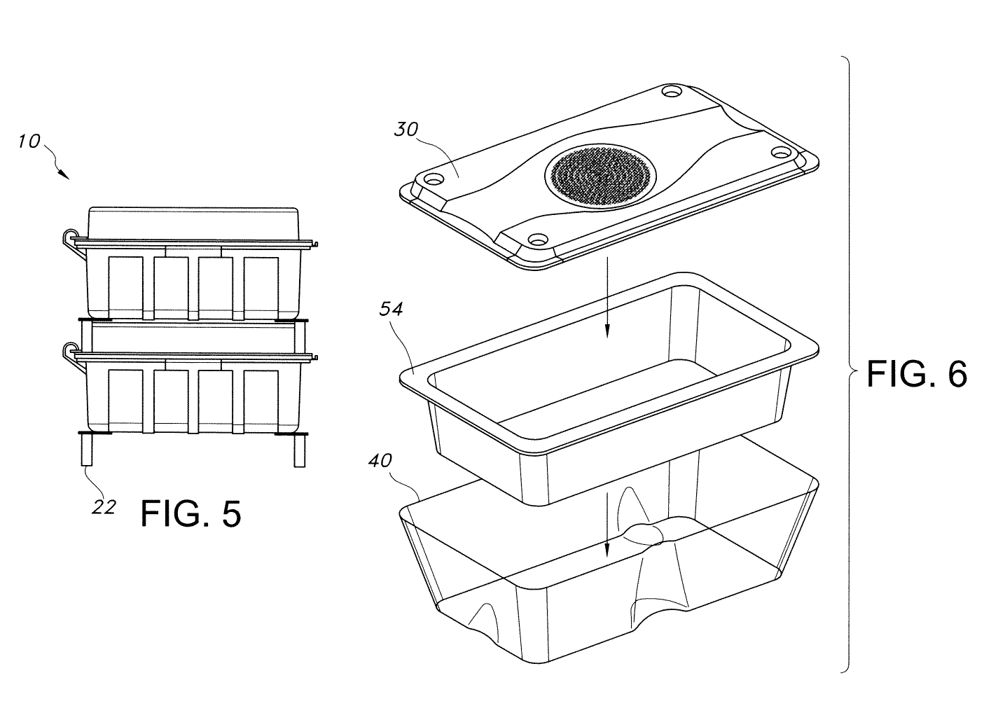

The frame 12 may further include feet 22, desirably in the four corners of the frame 12. The feet 22 may be used to stack or “nest” the containers one atop the other. This stacking may be done with empty containers and with full containers while instruments are awaiting sterilization or after they have been sterilized. Sterilized containers are often stacked in hospital store rooms in anticipation of surgical operations. The feet 22 may be designed to hang over the lip 34 of the lid 30 (FIGS. 3 and 5) or may be designed to rest on the lid 30, desirably in depressions 36 in the lid 30 designed for this purpose (FIG. 4). The feet need not extend very far below or beyond the frame, merely far enough to keep the upper container from shifting due to vibration or jostling of the stacked containers. It is desirable that the feet be of the type that extend beyond the edge of the lid rather than rest on the lid. As discussed, the lid is desirably made from and inexpensive and disposable polymer and so may not be capable of holding the load of a number, for example three or four, additional containers resting on it. If the feet extend beyond the edge of the container they should desirably rest such that the weight of the upper container is borne on the frame of the container below. Since the lid desirably sits on the top of the frame rim, FIG. 1, the feet should most likely rest on the top of the lid lip 34. This should transfer the weight of the upper container(s) to the frame of the lower container without distortion of the lid. The frame is desirably made from a more substantial material since it is desirably reusable. If this is the case, the more substantial frame would be better capable of carrying the weight of a number of other full instrument containers above it.

The use of feet is optional and other systems of placing the containers in a stable stacked orientation may be used if desired. For example, the upper surface of the lid may merely be formed with a slight depression over its entire surface where the depression is designed to be the same size as the bottom of the container. In another embodiment, the lid may be designed to have slots or depressions that mirror the design of the ribs (to be discussed below) of the bottom of the frame. These designs may be made “directional”, meaning that the design of the mating parts may be made such that the containers can only stack in a certain orientation, e.g., with each container having the same end facing the same direction. Using such a system, the containers need only be labeled on one end and may be arranged on a storage shelf in a stack where the labeled end is facing out for medical personnel to quickly access the desired container.

The frame 12 may be an open construction as illustrated in FIG. 1. In this embodiment, for example, four ribs run the longest dimension (longitudinal ribs 15) along the bottom of the frame and five ribs run in the shortest dimension (latitudinal ribs 17) of the frame. The ribs may be all of the same dimensions, e.g. width, thickness and shape, or the longitudinal and latitudinal ribs may differ in size and shape. The longer longitudinal ribs 15, for example, may be thicker or stiffer than the shorter latitudinal ribs 17. Desirable dimensions for the ribs may be from about 1 to 3 cm in width and 1 to 5 mm in thickness. The ribs desirably have a rectangular cross-section, though square, I-beam or other shapes should function as well. It is desirable that the ribs be solid and not hollow, as there is concern that hollow ribs could provide a location for the retention of moisture after steam sterilization.

The longitudinal and latitudinal ribs as shown in FIG. 1 cross each other at right angles and so produce a grid work with a rectangular aperture 19 between them. This is not a requirement of this disclosure but is shown as an example and as a likely relatively easily constructed format. The longitudinal and latitudinal ribs may be arranged so as to cross at virtually any angle. For example, one set of ribs may cross the other at a 45 degree angle or at a 30 degree angle, producing an aperture of a triangular or trapezoidal shape. Likewise the ribs, though shown in FIG. 1 as continuing from rim to rim of the frame, need not be restricted to such a construction. Ribs may be constructed in such as way as to begin in the bottom of the frame and continue to the rim or may begin and end on the bottom of the frame (thus forming a portion of the bottom of the frame) and not continue to the rim.

The shape of the ribs in the transition from the vertical sides of the container to the bottom is desirably slightly rounded, a shape that is desirably matched by the liner so that the ribs of the frame may provide support to the outside of the liner. Rounded ribs also likely make the “nesting” of frames together for storage while they are not being used easier than if they were made with sharp right angled lower corners. Frames made as described herein using ribs that are spaced apart should be easy to be cleaned in the hospital cleaning facility. Because of their desirable nesting design, many frames should fit into the cleaning machines, reducing time and energy costs for cleaning. Their open construction will minimize the amount of moisture retained by the frames after washing in, for example, an industrial dish washer. This will reduce drying time, again saving time and energy. Their relative light weight and small volume when nested will allow them to be transported to storage quickly and easily.

The frame should be made from materials that are durable in steam and ethylene oxide sterilization, as noted above. Such materials include polymers that are stable in such conditions and more likely, metals such as stainless steels. More desirable materials include austenitic or 300 series stainless steels like 304SS and 316SS. Stainless steel is also advantageous because when the frame eventually arrives at the end of its useful life, whether through damage from, for example, being dropped on a hard surface, or through simple wear and tear, the frame is completely recyclable. This, aside from being a good policy for materials generally, can help make the frame system disclosed herein still more economical by reducing the cost of replacement.

The frame 12 may also be a continuous or solid container bottom. If the frame is a solid bottom, it is desirable but not required that at least a portion of the bottom be transparent so that the medical professional may see the contents of the chamber. The frame, for example, may be the currently used hospital sterilization container bottom. These containers use a metal lid and bottom that are adapted to contain the instrument tray. Again, the solid container may be provided with feet that rest on the lid of a container below or may have feet that are located somewhat farther out on the bottom of the frame so that they rest on the lip of the lid and transfer their weight to the frame below.

Containers 10 are generally about 36 cm (14.25 inches) long by about 17 cm (6.85 in) wide by about 16 cm (6.25 in) in height. Another common size is 58 cm long (23 in) by 34 cm (13.5 in) wide by 16.5 cm (6.5 in) in height. Other sizes and dimensions of the container may be available or may be made so these sizes are not meant to be seen as a limitation of the disclosed device. In one embodiment, for a container that is 36 cm long and 17 cm wide, the ribs of the frame on the longest side could number five and be arranged with one in the center of the side, one at each end of the side, and two evenly spaced between the center and each end rib. Using ribs that are 1.5 cm wide, this results in an on-center spacing between ribs of 9 cm. The shorter ribs could number four and be evenly spaced without a center rib giving a spacing of 4.25 cm between center lines of each rib. Other orientations are calculable by those skilled in the art.

The lid 30 and more desirably the liner 40 may desirably be formed of, or include sections containing, a substantially transparent material that is able to withstand exposure to steam, ethylene oxide, or other forms of sterilization without degradation. This allows the contents of the container to be at least partially visible after sterilization and prior to removal of the lid. By “substantially transparent” what is meant is that a user may see through the material with the unaided eye under ambient light conditions sufficiently to distinguish between the items in the container. Accordingly, for purposes of the present disclosure “ambient light conditions” refers to light conditions of between about 500 lux (lx) and 2000 lx, more desirably, from about 750 lx to about 1500 lx as determined in accordance with the British Standards Institution Code of Practice for Day-lighting, BS 8206 Part 1. Having at least a portion of the lid or liner being substantially transparent allows the contents of the container to be at least partially visible before and after sterilization and prior to removal of the lid.

The materials of the container should be able to withstand sterilization temperatures of from about 135° F. (59° C.) for some gas or plasma sterilization processes to about 300° F. (149° C.) for certain steam sterilization processes without melting, bending, or losing strength. For example, the materials used for the lid, liner, basket and frame should be able to withstand steam sterilization temperatures ranging from about 266° F. (120° C.) to about 300° F. (149° C.) without melting, bending, or losing strength.

Desirably, the lid and liner may be made of a recyclable material such as, for example, a thermoplastic polymeric material. Exemplary materials include polypropylene, polyethylene, polyesters, certain thermoplastic polyurethanes, olefinic copolymers and the like. The liner 40, as mentioned above, is desirably made from a polymeric material since it is desirable that the liner be substantially transparent or that at least a portion of the liner be substantially transparent, but thin metal materials may also be used if transparency is not required. Suitable metals include aluminum and copper and various alloys.

While it is contemplated that the disposable liner will be of a thickness of a film or foil, i.e., on the order of microns in thickness, it is certainly possible to make a thicker, more rigid liner for specialized purposes. For example, the liner may be made from polypropylene 2 or more millimeters thick, giving it substantial strength. In another embodiment, the liner may be made from a thin metal like aluminum. In such cases it may even be possible to avoid the use of the frame altogether and merely insert the hospital instrument basket into the liner, attach the lid and sterilize the resulting container. The increased thickness provides the strength needed during the sterilization process and for handling and also provides greater puncture resistance when compared to the film or foil-thickness liner. The aluminum liner may then be recycled.

The lid 30 is desirably disposable like the liner 40 or reusable like the frame 20. As mentioned above, the lid may also be the existing hospital sterilization container lid which are made of metal and are substantial enough to be used numerous times.

The lid 30 desirably comprises a permeable filter 32. The permeable filter 32 provides a path for a sterilant to enter the chamber 52 from outside the container 10. The permeable filter 32 also maintains aseptic conditions inside the chamber 52 after sterilization by allowing gases such as air to enter or exit the chamber without allow passage of microorganisms. The permeable filter 32 is desirably located in the central area of the lid 30 and is contains one or more openings and/or passages between the outside of the container 10 and the chamber 52. The permeable filter 32 may, however, be located in other portions of the lid 30 or in the liner. If the permeable filter is located on the liner, it is desirably on one of the sides and not the bottom. A plurality of filters may be located on the liner on, for example, opposite sides so there is a flow through of sterilizing gasses. Lastly, it is possible for both the lid and the liner to have permeable filters so that gases may enter and exit the container at a plurality of locations.

The permeable filter may be a conventional filter material typically used for sterilization container applications and should be inexpensive enough to be discarded or recycled after a single use. Exemplary filter materials include, for example, nonwoven filter materials such as medical grade paper, polyolefin meltblown materials and multilayer nonwoven laminate materials such as laminates of spunbond materials and meltblown materials. Generally, gas permeable materials which may be used in the present disclosure are permeable to water vapor and have a minimum water vapor transmission rate (WVTR) of about 200 g/m²/16 hours, calculated in accordance with ASTM Standard E96-80. Suitable medical grade paper includes, for example, AMCOR PLP reinforced coated paper available from AMCOR, Limited.

As used herein the term “spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface. Spunbond fibers are generally continuous and have average diameters (from a sample of at least 10) larger than 7 microns, more particularly, between about 10 and 20 microns. The fibers may also have shapes such as those described in U.S. Pat. No. 5,277,976 to Hogle et al., U.S. Pat. No. 5,466,410 to Hills and U.S. Pat. No. 5,069,970 and U.S. Pat. No. 5,057,368 to Largman et al., which describe fibers with unconventional shapes.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers are microfibers which may be continuous or discontinuous, are generally smaller than 10 microns in average diameter, and are generally tacky when deposited onto a collecting surface.

As used herein “multilayer nonwoven laminate” means a laminate wherein some of the layers are spunbond and some meltblown such as a spunbond/meltblown/spunbond (SMS) laminate and others as disclosed in U.S. Pat. No. 4,041,203 to Brock et al., U.S. Pat. No. 5,169,706 to Collier, et al, U.S. Pat. No. 5,145,727 to Potts et al., U.S. Pat. No. 5,178,931 to Perkins et al. and U.S. Pat. No. 5,188,885 to Timmons et al. Such a laminate may be made by sequentially depositing onto a moving forming belt first a spunbond fabric layer, then a meltblown fabric layer and last another spunbond layer and then bonding the laminate in a manner described below. Alternatively, the fabric layers may be made individually, collected in rolls, and combined in a separate bonding step. Such fabrics usually have a basis weight of from about 0.1 to 12 osy (6 to 400 gsm), or more particularly from about 0.75 to about 3 osy. Multilayer laminates may also have various numbers of meltblown layers or multiple spunbond layers in many different configurations and may include other materials like breathable films (F) or coform materials, e.g. SMMS, SM, SFS, etc.

The rim 46 of the liner 40 may include a gasket material which is heat activated during sterilization (e.g., steam sterilization) to secure the lid 30 and/or the frame 20 to the liner. Such heat activated material may be a shape changeable element, an adhesive, or combinations thereof. It is believed that the heat of steam sterilization provides the energy source necessary to melt, soften, or deform the shape of the rim 46 to engage the lid 20 and frame 20. Such means of changing shape include melting, plastic flow, shrinkage, warping, expansion, twisting, kinking, and melding. Suitable materials for inclusion in the rim 46 include hot melt adhesives made from polyolefins, block copolymers, resins, waxes and combinations thereof. Desirably, these materials will have a melting point below 270° F. (132° C.). In one embodiment, a single sided tape may be used between the liner and the frame and also between the liner and the lip of the lid. The tape may be applied in a straight forward manner to both sides of the rim of the liner with the adhesive side desirably toward the liner. Placing the tape in this configuration allows the clean separation of the lid, liner and frame from each other after sterilization. This configuration also allows the recycling of the liner with the tape attached to it and without any adhesive remaining on the frame and lid. The frame and lid are then ready for reuse without undue cleaning.

In still another embodiment, the container may use a film outer liner 40 or bag, a thin inner metal basket 54 to replace the hospital's existing instrument basket, and the lid 30 (FIG. 6). In this case the lid 30 may be disposable or reusable while the basket 54 and liner 40 are disposable. The reusable frame 20 may also be used but is not required. In order to use this embodiment, the instruments are placed into the inner metal basket and the basket placed in the outer liner. The upper portion of the outer liner is then folded over the upper edge of the basket and into the basket. The lid is adapted to mate with the upper edge of the metal basket and the liner forms a gasket between the lid and basket where it has been folded over the top of the basket and into the basket. Single sided tape may be used on the lower side of the lid lip to form a gasket between the lid and the liner or alternatively the liner itself may for a gasket. The lid has the permeable filter to allow penetration of the sterilization gas. After sterilization, the outer liner should prevent microorganisms from entering the basket by forming a barrier between the basket and lid. Upon the conclusion of the medical procedure, the lid, outer liner and basket may be recycled or reused, as is appropriate depending on the materials of the construction of each part and local regulations.

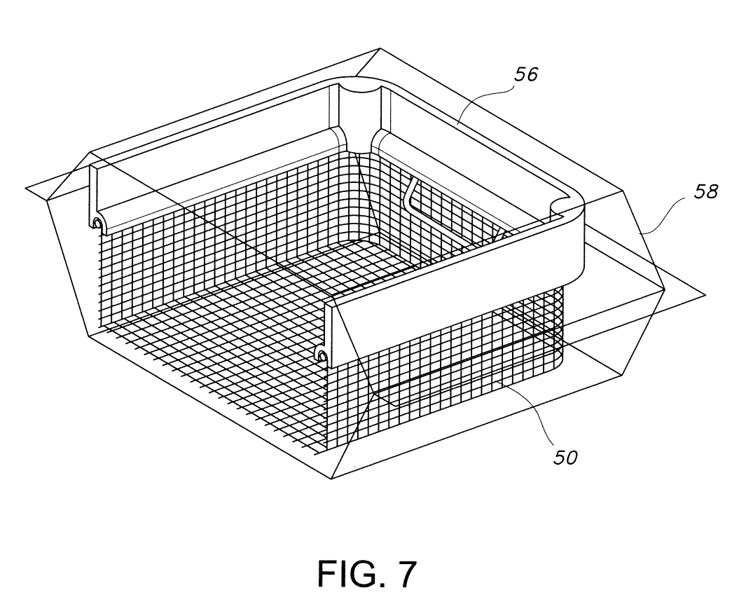

In another embodiment, a disposable or reusable extension 56 may be placed on top of the hospital's instrument basket 50 or the disposable metal basket 54 to raise the height of the basket 50 (FIG. 7). This allows for the sterilization of more instruments than can normally fit into one instrument basket 50. The basket 50 and extension 56 are then placed in a liner that is necessarily taller than the liner in the embodiments without an extension or, alternatively, a large disposable polymeric bag 58, for sterilization. The bag may have perforations or other areas of weakness so that it is easier to tear open, or may merely be cut with a knife or scissors to open it. The open end of the bag must be sealed tightly prior to sterilization so that microbial re-contamination does not occur after sterilization. It is also important that at least a portion of the bag 58 be substantially transparent, as defined above, so that the user may check the contents of the bag and know that the correct instruments are present for the surgery at hand. In addition, the bag 58 must have a permeable filter present, desirably on the top and/or sides, to allow for the passage of sterilizing gas. After the basket and extension have been successfully sterilized inside the bag 58, the bag may be cut and disposed of. Alternatively the bag may be designed with partial perforations present in a pattern around the bag so that it may be pulled apart at the point of weakness provided by the partial perforations. The basket and extension may then be removed for use of the instruments in surgery. Since the basket and extension are inserted into the bag in this embodiment, the tolerance between the parts need not be so precise as in other embodiments. In this case the life of the instrument basket and extension should be quite long unless they are severely damaged.

When it is necessary to sterilize instruments, the preparation of a container for sterilization should be quite quick and uncomplicated. In the sterilization preparation are of the hospital, a previously cleaned frame can be taken from the nested frame storage area and placed on a flat surface. A liner can then be retrieved from the new liner box where numerous liners are packaged together, and placed in the frame as shown in FIG. 1. The instrument basked can be placed in the liner, having been loaded with instruments previously or after the basket is placed in the liner. Once the correct instruments are loaded into the liner a lid may be placed on top of the frame with the rim of the liner between the lip of the lid and the rim of the frame. In the use of the disclosed device having a lid and liner, once the instruments are placed in the basket in the liner and frame (if used), the lid is locked onto the frame, or if no frame is used, onto the liner, prior to entering a sterilization chamber. Desirably the lid will include one or more locking mechanisms that allow the peripheral portion of the lid to fixedly engage the rim of the liner and/or frame.

The lock mechanism desirably incorporates a cinching or clamping mechanism to draw the two components to be joined tightly together, particularly in the case where a gasket is formed to maintain sterility after sterilization. Such a clamping mechanism may be for example cam clamps, cylinder clamps, hook/swing clamps, pull clams, push clamps, toggle clamps and others known to those skilled in the art. A means to ensure that the sterilized container is not opened and reclosed prior to its use is also desirable. Such means generally include a “tie” type system like a one-way wire tie that must be cut to be removed. Similar methods are used in containerized shipping to alert the shipping or port authority personnel that a container has been broken into. The use of such a tie closure system provides the user with the assurance that a container that has been in storage has not been inadvertently opened and its sterility lost while it has been waiting to be used.

Once the sterilization containers of the present disclosure containing the items to be sterilized are placed within the sterilization chamber, the sterilization chamber is closed and a gas sterilant is introduced into the container. The amount of time the items in the compartment are subjected to the gas sterilant depends on various factors, including the type of gas sterilant used, the number of medical instruments placed in the sterilization container as well as other factors. Those skilled in the art will be able to determine the appropriate amount of time the gas sterilant should remain in the chamber based on these and other factors. The successfully sterilized containers are then removed from the chamber and stored or prepared for use.

The current disclosure includes, in addition to the numerous embodiments describe previously, the associated method for each embodiment. For example, the method includes providing a frame having ribs and a rim, inserting a liner having a rim into the frame, placing medical instruments to be sterilized into the liner, either with or without an instrument basket, placing a lid having a permeable filter on top of the liner and frame and locking it into place and sterilizing the container thus formed. Additional steps include the removal of the sterilized container from the sterilization apparatus, and opening the container to use the sterilized instruments for surgery. Inspection of the contents of the container through the liner which is desirably made from substantially transparent materials is still another step of the disclosed device and method. Recycling of the lid and liner, and cleaning and storage of the used frame is also contemplated.

While various patents have been incorporated herein by reference, to the extent there is any inconsistency between incorporated material and that of the written specification, the written specification shall control. In addition, while the disclosure has been described in detail with respect to specific embodiments thereof, it will be apparent to those skilled in the art that various alterations, modifications and other changes may be made to the disclosure without departing from the spirit and scope of the present disclosure. It is therefore intended that the claims cover all such modifications, alterations and other changes encompassed by the appended claims.

We claim:

1. A locking container for sterilizing and preserving surgical materials in a sterilized condition, the container comprising:
a lid comprising a central portion and a continuous lip, wherein the lid and the basket together define a chamber for containing surgical items;
a liner comprising a liner base, liner sides and a continuous liner rim, the liner adapted to receive a basket for containing surgical instruments such that the liner and lid rim and said lip together form a barrier to inhibit the passage of microorganisms into the chamber;
a permeable filter providing a path for a sterilant to enter the chamber from outside the container and for maintaining aseptic conditions inside the chamber after sterilization; and
a lock for securing the lid and liner together.

2. The container of claim 1 further comprising a frame comprising a base, a plurality of frame sides and a continuous frame rim, the frame sides being in communication with the frame base and the frame rim defined by the distal portions of the frame sides, the frame adapted to receive the liner, basket and lid, and wherein said frame rim mates with said lid lip.

3. The container of claim 2, wherein the frame further comprises a plurality of feet adapted to enable multiple frames and lids to be stacked one on top of the other.

4. The container of claim 3, wherein said lid has a like number of depressions in said lid adapted to accept said feet.

5. The container of claim 1, wherein the liner is made from a material selected from the group consisting of polypropylene, polyethylene, polyesters, thermoplastic polyurethanes, olefinic copolymers, aluminum, copper and various alloys.

6. The container of claim 1 further comprising an extension that is placed on top of the basket to raise the height of the basket.

7. The container of claim 1 wherein said basket is disposable and is made from a material selected from the group consisting of polypropylene, polyethylene, polyesters, thermoplastic polyurethanes, olefinic copolymers, aluminum, copper and various alloys.

8. The container of claim 6, wherein the rim of the liner includes a material which is heat activated during steam sterilization to secure the lid to the liner.

9. The container of claim 8 wherein said material for inclusion in the rim includes hot melt adhesives made from polyolefins, block copolymers, resins, waxes and combinations thereof, that have a melting point below 270° F. (132° C.).

10. The container of claim 1, wherein the lid has a gas permeable filter is in the central portion of the lid.

11. The container of claim 10, wherein the filter material is selected from the group consisting of medical grade paper, polyolefin meltblown materials and nonwoven laminate materials such as laminates of spunbond materials and meltblown materials.

12. The container of claim 11 wherein said gas permeable filter material is permeable to water vapor and has a minimum water vapor transmission rate (WVTR) of about 200 g/m²/16 hours, calculated in accordance with ASTM Standard E96-80.
